(19) United States
(12) Patent Application Publication
(10) Pub. No.: US 2026/0094279 A1
(43) Pub. Date: Apr. 2, 2026

(54) SINGLE-IMAGE CAPTURE DOCUMENT BOUNDARY DETECTION VIA MULTI-DIRECTIONAL SPECTRALLY-DISTINCT ILLUMINATION

(71) Applicant: IRON MOUNTAIN INCORPORATED, Portsmouth, NH (US)

(72) Inventor: William J. Allen, Corvallis, OR (US)

(73) Assignee: IRON MOUNTAIN INCORPORATED, Portsmouth, NH (US)

(21) Appl. No.: 18/902,495

(22) Filed: Sep. 30, 2024

(51) Int. Cl. G06T 7/13; G06T 7/90; H04N 1/028; H04N 1/195

(52) U.S. Cl. CPC G06T 7/13; G06T 7/90; G06T 2207/10008; G06T 2207/10024; G06T 2207/30176; H04N 1/02815; H04N 1/19594

(57) ABSTRACT

A boundary detection system accesses an image captured of an environment comprising a first object illuminated by a plurality of distinct wavelengths of light, each of the distinct wavelengths of light originating from emanating from respective lighting sources at respective distinct directions from the first object. The boundary detection system detects, based on color channel data of the image corresponding to one or more of the plurality of distinct wavelengths of light, boundaries of the first object in the image. The boundary detection system annotates the detected boundaries in the image.

### TECHNICAL FIELD

This disclosure generally relates to techniques for scanning physical items. More specifically, but not by way of limitation, this disclosure relates to detecting edges/boundaries of stacked physical items in a scanned image of the stacked physical items.

### BACKGROUND

Conventional systems and devices for scanning documents can have difficulty identifying edges/boundaries of an object that is stacked on top of one or more other objects, especially when the object and the other objects upon which the object is stacked are of a same color or are of a similar color. For example, it can be challenging, when scanning a stack of paper documents, to discriminate edges of a document of interest when it is stacked on top of documents having a similar appearance (e.g., first sheet of printer paper stacked on top of another sheet of printer paper).

### SUMMARY

The present disclosure describes techniques for detecting boundaries of an object in an image of the object illuminated using multi-directional spectrally distinct light sources. A boundary detection system accesses an image captured of an environment comprising a first object illuminated by a plurality of distinct wavelengths of light, each of the distinct wavelengths of light originating from emanating from respective lighting sources at respective distinct directions from the first object. The boundary detection system detects, based on color channel data of the image corresponding to one or more of the plurality of distinct wavelengths of light, boundaries of the first object in the image. The boundary detection system annotates the detected boundaries in the image.

Various embodiments are described herein, including methods, systems, non-transitory computer-readable storage media storing programs, code, or instructions executable by one or more processing devices, and the like. These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a computing environment for detecting boundaries of an object in an image of the object illuminated using multi-directional spectrally distinct light sources, according to certain embodiments disclosed herein.

FIG. 2 depicts a method for detecting boundaries of an object in an image of the object illuminated using multi-directional spectrally distinct light sources, according to certain embodiments disclosed herein.

FIG. 3 illustrates detection of boundary portions of an object using color channel data of an image of the object illuminated using multi-directional spectrally distinct light sources, according to certain embodiments disclosed herein.

FIG. 4 depicts an example of a computing system that performs certain operations described herein, according to certain embodiments disclosed herein.

FIG. 5 depicts an example of a cloud computing system that performs certain operations described herein, according to certain embodiments disclosed herein.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The words “exemplary” or “example” are used herein to mean “serving as an example, instance, or illustration.” Any embodiment or design described herein as “exemplary” or “example” is not necessarily to be construed as preferred or advantageous over other embodiments or designs.

Conventional systems and devices for scanning documents can have difficulty identifying edges/boundaries of an object that is stacked on top of one or more other objects, especially when the object and the other objects upon which the object is stacked are of a same color or are of a similar color. For example, it can be challenging, when scanning a stack of paper documents, to discriminate edges of a document of interest when it is stacked on top of documents having a similar appearance when viewed with overhead illumination. Conventional systems have attempted to address this by multi-directional illumination and capturing of separate images corresponding to illumination of the object from various directions. However, such conventional techniques require capture of multiple images of the object. For example, a conventional system may capture a first image of an object illuminated from a light source to the west of the object, a second image of the object illuminated from a light source to the north of the object, and a third image of the object illuminated from a light source to the east of the object. In this example, the conventional system can detect an eastern boundary of the object in the first image, a southern boundary of the object in the second image, and a western boundary of the object in the third image, based on shadow effects caused by the interaction of the respective directional light with the object in each of the three images. In such conventional techniques, illuminating the object from multiple directions (e.g., illuminating from both the east and west simultaneously) results in a washing out of shadow effects in the image that are necessary for detecting boundaries of the object.

Certain embodiments described herein address the limitations of conventional boundary detection systems by detecting boundaries of an object in a single image captured of the object illumined by a plurality of spectrally distinct lighting sources illuminating the object from multiple directions. For example, the methods provided herein can illuminate the object from a first direction (e.g. from the west) with a first distinct wavelength of light (e.g. red light), from a second direction (e.g. from the north) with a second distinct wavelength of light (e.g. green light), and from a third direction (e.g. from the east) with a third distinct wavelength of light (e.g. blue light). Using spectrally distinct multi-directional illumination as described herein avoids shadow cancellation effects encountered in conventional scanning applications that use multi-directional illumination. Because shadows are not washed out in the captured image in the methods described herein, boundaries of an object can be determined from a single captured image of the object. Specifically, in the system and methods described herein, respective portions of boundaries of an object can be determined from individual color channel data (e.g. red, green, blue color channels) of a single image without requiring capture of multiple images. Accordingly, the system and methods described herein, when compared to conventional scanning methods, reduce both bandwidth usage as well as storage requirements by reducing an amount of image capture/storage operations and reducing an amount of operations required to illuminate the object during scanning. For example, the system and methods described herein enable capture of a single image instead of the sequential capture and storage of multiple successive images performed by conventional scanning methods. For example, the system and methods described herein enable a simultaneous illumination of multiple spectrally distinct light sources instead of sequential activation and deactivation of light sources between successive image captures performed by conventional scanning methods. Further, the system and methods described herein, when compared to conventional scanning methods, also reduce a processing time for detecting boundaries of an object by reducing the amount of image capture/storage operations and reducing the amount of operations required to illuminate the object during scanning.

The following non-limiting example is provided to introduce certain embodiments. In certain embodiments, a boundary detection system accesses an image captured of an object that is illuminated by multi-directional spectrally distinct light sources. In some instances, the image is captured by a scanning device, for example, a document scanner. The object could be a paper document. In some instances, the object (e.g. paper document) is stacked on top of another object (e.g. another paper document) such that one or more boundary regions of the object are not distinguishable with conventional overhead lighting. For example, boundary regions of the object may not be visible where these boundary regions overlap a surface of the other object upon which the object is stacked. In some instances, the multi-directional spectrally distinct light sources are positioned around a scanning location of the scanning device. For example, the multi-directional spectrally distinct light sources comprise three light sources: a first light source is positioned at a first position, a second light source is positioned at a second position, and a third light source is positioned at a third position with respect to the object. Other numbers of multi-directional spectrally distinct light sources may be used, however, for example, two, four or another number. In some instances, the light sources are positioned perpendicularly and/or at opposite poles with respect to the object (e.g. at 90 degrees to one another, for instance, at North, South, East, and/or West positions with respect to the object). The multiple light sources are spectrally distinct, for example, their wavelengths can be detected in the light spectrum. In some instances, the light spectrum over which the wavelengths are spectrally distinct includes only the visible light spectrum. In some instances, however, the light spectrum over which the wavelengths are spectrally distinct includes the electromagnetic spectrum including one or more of the ultraviolet light spectrum, the visible light spectrum, the infrared light spectrum or other regions of the electromagnetic spectrum. In one example, the first light source is a green light source at a west position, the second light source is a blue light source at a north position, and the third light source is a red light source at an east position with respect to the object. In some instances, at or before a time the image of the object is captured, the scanning device activates the multi-directional spectrally distinct light sources so that the object is illuminated by all of the light sources together. Upon the illumination of the object by the multi-directional spectrally distinct light sources, the scanning device captures an image of the object (e.g. from a camera located above the object) and stores the image in a data storage unit. The boundary detection system accesses the captured image from the data storage unit.

In certain embodiments, the boundary detection system detects, based on color channel data in the captured image corresponding to respective spectrally distinct light sources that illuminated the object in the captured image, boundaries corresponding to the object. For example, the boundary detection system detects a first portion of a boundary of the object using first color channel data (e.g. a green color channel) of the captured image, detects a second portion of a boundary of the object using second color channel data (e.g. a blue color channel) of the captured image, and detects a third portion of a boundary of the object using third color channel data (e.g. a red color channel) of the captured image. For example, each pixel of the image comprises a value for each of a set of color channels. In some instances, each pixel may comprise red-green-blue (“RGB”) color values and accessing a red color channel, a green color channel, or a blue color channel comprises accessing respective red, green, or blue color values for each pixel in the image. The color values for a particular color channel may indicate an intensity of light of the respective color associated with the pixel of the image. In some instances, the boundary detection system applies an edge/boundary detection algorithm to each respective color channel data to determine a respective portion of the boundary of the object. In some instances, the edge/boundary detection model detects a shadow effect appearing along one or more edges of the object and determines that the boundary portions of the object correspond to locations in the image depicting the shadow effect. In some instances, the boundary detection system can determine a portion of the boundaries of the object by applying the edge/boundary detection algorithm to a combination of two or more color channels (e.g., blue+red, blue+green, or red+green color channels). For example, the boundaries of the object comprise all of the detected portions of the boundaries detected by applying the edge/boundary detection algorithm to each color channel of the captured image.

In certain embodiments, the boundary detection system displays an output on a user interface based on the determined boundaries of the object. In some instances, the boundary detection system indicates the boundaries on the user interface. For example, the boundary detection system displays the captured image and annotates the boundaries of the object in the displayed image. In some instances, the boundary detection system generates, for display on the user interface, an output image of the object based on the detected boundaries of the object. For example, the boundary detection system generates an output image that only depicts the object (e.g. the document of interest) and not any other features (e.g. documents upon which the document is stacked, a background of the scanning area, etc.) captured in the input image. In some instances, generating the output image comprises rotating, resizing, warping, or performing other image modification operations to a subregion of the image depicted within the detected boundaries. For example, the stacked object document is rotated 10 degrees from a vertical axis in the captured image but, in the displayed output image, is depicted aligned with the vertical axis.

### Example Operating Environment for Detecting Boundaries of an Object in an Image of the Object Illuminated Under Multi-Directional Spectrally Distinct Illumination

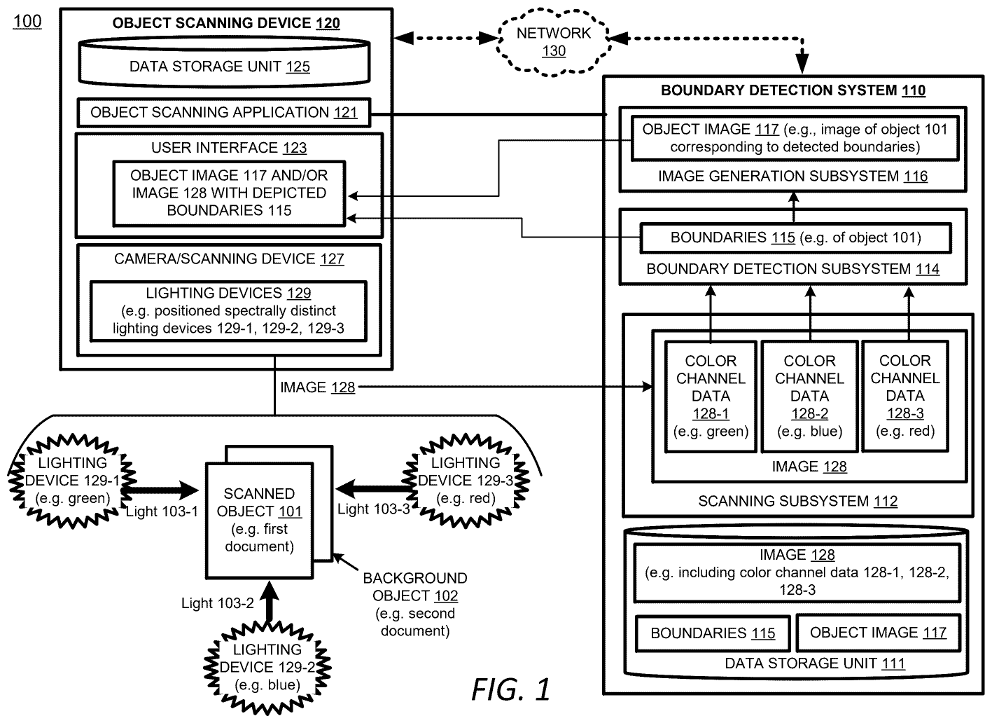

Referring now to the drawings, FIG. 1 depicts an example of a computing environment 100 for detecting boundaries 115 of an object 101 in an image 128 of the object 101 illuminated using multi-directional spectrally distinct illumination. In certain embodiments, the computing environment 100 includes an object scanning device 120 and the boundary detection system 110, including a scanning subsystem 112, a boundary detection subsystem 114, and a image generation subsystem 116, is a component of an object scanning application 121 that executes on the object scanning device 120. In certain embodiments, the computing environment 100 includes the object scanning device 120 and the boundary detection system 110 that communicates via a network 130 with the object scanning device 120. In certain embodiments, each of the scanning subsystem 112, the boundary detection subsystem 114, and the image generation subsystem 116 is a network server or other computing device connected to a network 130.

In certain embodiments, the scanning subsystem 112 access or otherwise receives an image 128 of an object 101 captured by an object scanning device 120. In certain examples, the image 128 of the object 101 is an individual captured image 128 or is a single frame of a live camera view captured by a camera/scanning device 127 of the object scanning device 120. For example, the object scanning device 110 that captured the image 128 stored the image in the data storage unit 111 or in the data storage unit 125 and the scanning subsystem 112 accesses the image 128 from the data storage unit 111 or from the data storage unit 125, respectively. In some instances, upon capturing the image 128, the object scanning device 110 transmits the 128 to the scanning subsystem 112 and the scanning subsystem 112 receives the image 128 from the object scanning device 110. The scanning subsystem determines color channel data of the image 128, for example, color channel data 128-1, color channel data 128-2, and color channel data 128-3. In some instances, the color channel data 128-3, 128-2, and 128-1 comprise red, green, and blue color channel intensity values, respectively.

In some instances, the scanning subsystem 112 instructs the camera/scanning module 127 to activate lighting devices 129 that are positioned with respect to the object 101. For example, the lighting devices 129 comprise lighting devices 129-1, 129-2, and 129-3, which are spectrally distinct one from another (e.g., each emitting a different, distinct visible wavelength or distinct visible wavelength range of light). In some instances, upon the illumination of the object by the multi-directional spectrally distinct light sources, the scanning subsystem 112 instructs the camera/scanning module 127 to capture the image of the object 101 (e.g. from a camera position located above the object) and to store the image 128 in a data storage unit 111 (or data storage unit 125) or to transmit the image 128 to the scanning subsystem 112. The boundary detection system 112 accesses the captured image from the data storage unit 111 (or data storage unit 125) or receives the captured image 128 from the camera/scanning device 127.

In certain embodiments, the boundary detection subsystem 114 detects boundaries 115 for the object 101 in the image 128 based on the color channel data (e.g. color channel data 128-1, 128-2, and 128-3). For example, the boundary detection subsystem 114 detects a first portion of boundaries 115 of the object 101 by applying a boundary/edge detection algorithm to color channel data 128-1 (e.g. a green color channel) of the captured image 128, detects a second portion of the boundaries 115 of the object 101 by applying the boundary/edge detection algorithm to color channel data 128-2 (e.g. a blue color channel) of the captured image, and detects a third portion of the boundaries 115 of the object 101 by applying the boundary/edge detection algorithm to color channel data 128-3 (e.g. a blue color channel) of the captured image. In some instances, the boundary detection subsystem 114 detects a portion of the boundaries 115 of the object 101 by applying the boundary/edge detection algorithm to two or more color channels (e.g. color channel data 128-1 and 128-3) of the image 128. In some instances, the boundary detection subsystem 114 determines the boundaries 115 by combining the detected boundary portions. In some instances, the boundary detection subsystem 114 instructs or otherwise causes a user interface 123 of the object scanning device 120 to display the boundaries 115. For example, the boundary detection subsystem 114 instructs the user interface 123 to display the image 128 and to annotate the boundaries 115 of the object 101 in or on the image 128.

In certain instances, the image generation subsystem 116 generates, based on the determined boundaries 115 of the object 101 in the image 128, an object image 117. For example, the image generation subsystem 116 generates the object image 117 that only depicts the object 101 (e.g. the document of interest) and not any other features (e.g. documents upon which the document is stacked, a background of the scanning area, etc.) captured in the input image 128. In some instances, generating the object image 117 comprises extracting a subregion of the image 128 located at and within the boundaries 115 and rotating, resizing, warping, or performing other image modification operations to the subregion. For example, the subregion of the image 128 depicting the stacked object 101 is rotated 10 degrees from a vertical axis in the captured image 128 but, in the displayed object image 117, is depicted aligned with the vertical axis. In some instances, the image generation subsystem 116 instructs or otherwise causes the user interface 123 of the object scanning device 120 to display the object image 117.

The boundary detection system 110 includes a data storage unit 111. An example data storage unit 111 is accessible to the boundary detection system 110 and stores data for the boundary detection system 110. In some instances, the data storage unit 111 stores the image 128 of the object 101 captured by the object scanning device 120, including color channel data (e.g. color channel data 128-1, 128-2, and 128-3) associated with the image 128. For example, the stored image 128 data includes red-green-blue (“RGB”) color values for each pixel of the image 128. In some instances, the data storage unit 111 stores boundaries 115 of the object 101 detected by the boundary detection subsystem 114. In some instances, the data storage unit 111 stores an object image 117 generated by the image generation subsystem 116.

An example object scanning device 120 includes a camera/scanning device 127, a user interface 123, an object scanning application 121, and a data storage unit 125. In certain embodiments, the object scanning device 120 is a document scanning device including a plurality of lighting devices 129 (e.g. lighting devices 129-1, 129-2, and 129-3). In certain embodiments, the object scanning device 120 is a smart phone device, a personal computer (PC), a tablet device, or other user computing device having a camera capability and which is communicatively coupled to the plurality of lighting devices 129. In some embodiments, the object scanning device 120 communicates with the boundary detection system 110 via the network 130. In some embodiments, the boundary detection system 110 is a component of the object scanning application 121, for example, a component of the object scanning application 121.

The object scanning application 121, in some embodiments, is associated with the boundary detection system 110 and the user downloads the object scanning application 121 on the object scanning device 120. In some instances, the user accesses an application store or a website of the boundary detection system 110 using the object scanning device 120 and requests to download the object scanning application 121 on the object scanning device 120. The object scanning application 121 operates on the object scanning device 120 and enables a user of the object scanning device 120 to capture an image 128 an object 101 and determine boundaries 115 of the object 101 in the captured image 128. The object scanning application 121 can communicate with the user interface 123 to receive one or more inputs from the user. In some embodiments, the object scanning application 121 communicates with one or more of the scanning subsystem 112, the boundary detection subsystem 114, the image generation subsystem 116, or the data storage unit 111 of the boundary detection system 110. In certain embodiments, the object scanning application 121 includes the scanning subsystem 112, the boundary detection subsystem 114, the image generation subsystem 116 and performs the operations described herein as being performed by the subsystems 112, 114, and 116.

The user interface 123 can include a touchscreen display interface, a display device (e.g. a monitor) with a separate input device (e.g. a mouse), or other user interface 123 which can receive one or more inputs from the user and display information or provide other output to the user. For example, the user interface 123 can display a camera view of an environment including the object 101 (and, in some instances, a background object 102 upon which the object 101 is stacked) captured by the camera/scanning module 127. In some instances, the user interface 123 receives one or more inputs from the user, in some instances, instructing the object scanning application 121 to perform a scan of the object 101 to generate an image 128 including boundaries 115 of the object 101 depicted within the image 128. In some instances, the one or more inputs from the user received via the user interface 123 instruct the object scanning application 121 to perform a scan of the object 101 to generate an object image 117 depicting only the object 101.

The data storage unit 125 is accessible to the object scanning device 120 and stores data for the object scanning device 120. In some instances, the data storage unit 111 stores the image 128 of the object 101 captured by the object scanning device 120, including color channel data (e.g. color channel data 128-1, 128-2, and 128-3) associated with the image 128. For example, the stored image 128 data includes red-green-blue (“RGB”) color values for each pixel of the image 128. In some instances, the data storage unit 111 stores boundaries 115 of the object 101 detected by the boundary detection subsystem 114. In some instances, the data storage unit 111 stores an object image 117 generated by the image generation subsystem 116. In some instances, in which the boundary detection system 110 is separate from the object scanning device 120, the data storage unit 125 is accessible to the boundary detection system 110 via the network 130. For example, the boundary detection system 110 can access data stored in the data storage unit 125 via the network 130.

The camera/scanning device 127 is configured to capture an image 128 of an environment including the object 101 and one or more background objects 102 at least partially occluded by the object 101. In some instances, the camera/scanning device 127 comprises a plurality of multi-directional spectrally distinct lighting devices 129. In some instances, the lighting devices 129 are separate devices from the camera/scanning device 127 and are communicatively coupled to the camera/scanning device 127. In some instances, the multi-directional spectrally distinct light sources 129 (e.g. light sources 129-1, 129-2, and 129-3) are positioned in a camera view of the camera/scanning module 127 of the object scanning device 120. For example, as depicted in FIG. 1, the multi-directional spectrally distinct lighting devices 129 can comprise three lighting devices 129: a first lighting device 129-1, a second lighting device 129-2, and a third lighting device 129-3 positioned at respective positions with respect to a camera view of the camera/scanning device 127. Other numbers of multi-directional spectrally distinct lighting devices 129 may be used, however, for example, two, four or another number. In some instances, the lighting devices 129 are positioned perpendicularly and/or at opposite poles with respect to the object 101 (e.g. at 90 and/or 180 degrees to one another, for instance, at North, South, East, and/or West positions with respect to the object 101). However, other positions other than 90 and/or 180 degrees from the object may be used. For example, three lighting devices 129 positioned 120 degrees apart from each other with respect to the object 101 may be used. In one example, as depicted in FIG. 1, the lighting device 129-1 emits green light from a west position, the lighting device 129-2 emits blue light from a south position, and the lighting device 129-3 emits red light from an east position, where the positions are with respect to the object 101. The multiple lighting devices 129 are spectrally distinct, for example the green light, blue light, and red light (or other selection of wavelengths or wavelength ranges) emitted by the respective lighting devices 129 can be distinguished from each other within the visible light spectrum.

As depicted in FIG. 1, the camera/scanning module 127 can capture an image 128 of a camera view of the camera/scanning module 127. The camera view includes the object 101 positioned within the camera view and one or more background objects 102 upon or in front of which the object 101 is positioned. In some instances, the camera view includes a background surface upon which the object 101 and the one or more background objects 102 are positioned and, in some instances, includes the lighting sources 129. In certain examples, camera/scanning device 127 instructs the lighting devices 129 to illuminate the environment within the camera view of the camera/scanning device 127. For example, each of the lighting devices 129-1, 129-2, and 129-3 emits its respective spectrally distinct light 103-1, 103-2, and 103-3, respectively, toward the object 101 from its respective position. Upon or after illumination of environment (including the object 101) of the camera view of the camera/scanning device 127, the camera scanning device 127 captures an image 128 and the scanning subsystem 112 accesses or otherwise receives the image 128 and identifies color channel data 128-1, 128-2, and 128-3 of the captured image 128. The boundary detection subsystem 114 determines boundaries 115 of the object 101 within the image 128 by applying an image/edge detection algorithm to each of the color channel data 128-1, 128-2, and 128-3. In some instances, the boundary detection subsystem 114 causes the user interface 123 of the object scanning device 120 to display the image 128 and an annotation of the detected boundaries 115 of the object 101 within the image 128. In some instances, the image generation subsystem 116 generates, based on the image 128 and the detected boundaries 115 of the object 101, an object image 117 that is based on the object 101 portion of the original image 128 depicted within the boundaries 115 of the image 128. In some instances, the image generation subsystem 116 causes the user interface 123 of the object scanning device 120 to display the object image 117.

The object scanning device 120, including the scanning subsystem 112, the boundary detection subsystem 114, and the image generation subsystem 116, may be implemented using software (e.g., code, instructions, program) executed by one or more processing devices (e.g., processors, cores), hardware, or combinations thereof. The software may be stored on a non-transitory storage medium (e.g., on a memory component). The computing environment 100 depicted in FIG. 1 is merely an example and is not intended to unduly limit the scope of claimed embodiments. One of the ordinary skill in the art would recognize many possible variations, alternatives, and modifications. For example, in some implementations, the object scanning device 120 and/or the boundary detection system 110 can be implemented using more or fewer systems or subsystems than those shown in FIG. 1, may combine two or more subsystems, or may have a different configuration or arrangement of the systems or subsystems.

### Examples of Computer-Implemented Operations for Detecting Boundaries of an Object in an Image of the Object Illuminated Under Multi-Directional Spectrally Distinct Illumination

In the embodiments described herein, boundary detection system 110 can determine boundaries 115 of an object 101 within a single image 128 by applying an edge detection algorithm (or other boundary detection algorithm) to data associated with the single image 128. For example, the data associated with the single image 128 comprises three sets of color channel data 128-1, 128-2, and 128-3, and respective portions of the boundaries 115 are determined by applying the edge detection algorithm to the color channel data 128-1, 128-2, and 128-3, respectively. Further, in some instances, a portion of the boundaries 115 are determined by applying the edge detection algorithm to a combination of two or more sets of color channel data, for example, by applying the edge detection algorithm to a combination of color channel data 128-1 and color channel data 128-3.

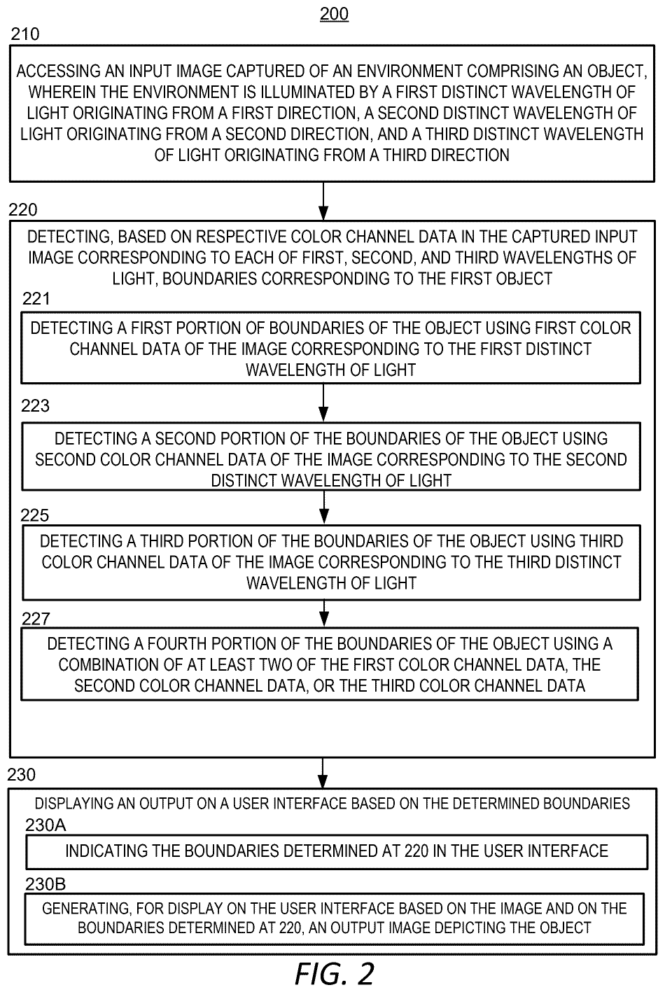

FIG. 2 depicts a method for detecting boundaries 115 of an object 101 in an image 128 of the object 101 illuminated using multi-directional spectrally distinct light sources, according to certain embodiments disclosed herein, according to certain embodiments disclosed herein. One or more computing devices (e.g., the object scanning device 120 or the individual subsystems contained therein) implement operations depicted in FIG. 2. For illustrative purposes, the method 200 is described with reference to certain examples depicted in the figures. Other implementations, however, are possible.

At block 210, the method 200 involves accessing, by a boundary detection system 110, an input image 128 captured of an environment comprising an object 101, wherein the environment is illuminated by a first distinct wavelength of light 103-1 from a first direction with respect to the object, a second distinct wavelength of light 103-2 originating from a second direction with respect to the object, and a third distinct wavelength of light 103-3 from a third direction with respect to the object. For example, the first distinct wavelength of light 103-1 emanates from a first lighting source 129-1, the second distinct wavelength of light 103-2 emanates from a second lighting source 129-2, and the third distinct wavelength of light 103-3 emanates from a third lighting source 129-3. For example, each of the lighting devices 129-1, 129-2, and 129-3 emits its respective spectrally distinct light toward the object 101 from its respective position. In some instances, each of the lighting devices 129-1, 129-2, and 129-3 is positioned, with respect to the scanned object 101, opposite to or perpendicular to each other of the lighting devices 129. The image 128 depicts an environment including the scanned object 101 and any background objects 102 in the camera view of the camera/scanning device 127 upon or after illumination of environment by the lighting devices 129.

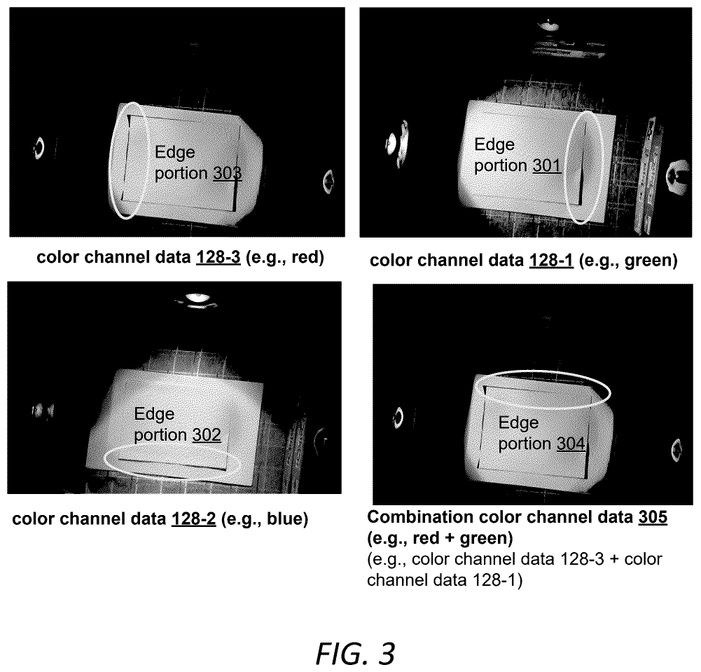

At block 220, the method 200 involves detecting, based on respective color channel data (128-1, 128-2, 128-3) in the image 128 corresponding to each of first, second, and third wavelengths of light, boundaries 115 corresponding to the object 101. The boundary detection system 110 applies an edge/boundary detection algorithm to each of the color channel data 128-1, 128-2, and 128-3 separately and/or to one or more combinations of two or more of the color channel data 128-1, 128-2 or 128-3 to determine respective portions of the boundaries 115. In some instances, applying the edge detection algorithm includes detecting, in individual color channel data 128-1, 128-2, or 128-3 or in a combination of two or more color channel data 128-1, 128-2, or 128-3, a shadow effect in a region of the image 128, wherein the region of the image 128 including the shadow effect defines a portion of the boundaries 115 of the scanned object 101. In some instances, the boundary detection system 110 constructs or otherwise determines complete boundaries 115 of the scanned object 101 within the image 128 based on the detected boundary portions from each application of the edge detection algorithm. FIG. 3 depicts a specific example for determining portions of boundaries 115 of the scanned object 101 in the image 128 by applying the edge detection algorithm to each of color channel data 128-1, 128-2, and 128-3 and to a combination of color channel data 128-1 and 128-3.

In some instances, implementing block 220 includes implementing each of subblocks 221, 223, 225, and 227. For example, a first lighting device 129-1 is positioned at a first direction from the object 101, a second lighting device 129-2 is positioned at a second direction from the object 101 perpendicular to the first direction, and a third lighting device 129-3 is positioned at a third direction from the object 101 opposite the first direction and perpendicular to the second direction. In this example, in the image 128, the object 101 is illuminated from light emanating each of the first lighting device 129-1 (e.g., green light 103-1), the second lighting device 129-2 (e.g., blue light 103-2), and the third lighting device 129-3 (e.g., red light 103-3).

At subblock 221, the method 200 for implementing block 220 involves detecting a first portion of boundaries 115 of the object 101 using first color channel data 128-1 of the image 128 corresponding to the first distinct wavelength of light 103-1. Detecting the first portion can involve applying an edge detection algorithm to the first color channel data 128-1 to detect a boundary portion corresponding to a shadow effect in the image 128 indicated in the first color channel data 128-1. In some instances, the first color channel data 128-1 comprises a green color channel corresponding to a green light 103-1 illuminating the object 101 depicted in the image 128. For example, the green light 103-1 illuminates the object 101 from a left/west side and the boundary detection system 110 detects, in the first color channel data 128-1, a dark shadow marking the right edge of the object 101.

At subblock 223, the method 200 for implementing block 220 involves detecting a second portion of boundaries 115 of the object 101 using second color channel data 128-2 of the image 128 corresponding to the second distinct wavelength of light 103-2. Detecting the second portion can involve applying an edge detection algorithm to the second color channel data 128-2 to detect a boundary portion corresponding to a shadow effect in the image 128 indicated in the second color channel data 128-2. In some instances, the second color channel data 128-2 comprises a blue color channel corresponding to a blue light 103-2 illuminating the object 101 depicted in the image 128. For example, the blue light 103-2 illuminates the object 101 from a top/north side and the boundary detection system 110 detects, in the second color channel data 128-2, a dark shadow marking the bottom edge of the object 101.

At subblock 225, the method 200 for implementing block 220 involves detecting a third portion of boundaries 115 of the object 101 using third color channel data 128-3 of the image 128 corresponding to the third distinct wavelength of light 103-3. Detecting the third portion can involve applying an edge detection algorithm to the third color channel data 128-3 to detect a boundary portion corresponding to a shadow effect in the image 128 indicated in the third color channel data 128-3. In some instances, the third color channel data 128-3 comprises a red color channel corresponding to a red light 103-3 illuminating the object 101 depicted in the image 128. For example, the red light 103-3 illuminates the object 101 from a right/east side and the boundary detection system 110 detects, in the third color channel data 128-3, a dark shadow marking the left edge of the object 101.

At subblock 227, the method 200 for implementing block 220 involves detecting a fourth portion of boundaries 115 of the object 101 using a combination of at least two of the color channel data 128-1, 128-2, and 128-3. Detecting the fourth portion can involve applying an edge detection algorithm to the combination of the at least two of the color channel data 128-1, 128-2, and 128-3 to detect a boundary portion corresponding to a shadow effect in the image 128 indicated in the combination of the at least two of the color channel data 128-1, 128-2, and 128-3. In some instances, the combination of the at least two of the color channel data 128-1, 128-2, and 128-3 is a combination of color channel data 128-1 and 128-3 representing a combination of green and red light 103-1 and 103-3 illuminating the object 101 depicted in the image 128. However, other combinations of color channel data may be used. For example, the green light 103-1 and red light 103-3 illuminates the object 101 from a left/west side and a right/east side, respectively, and the boundary detection system 110 detects, in the combined color channel data, a dark shadow marking the top edge of the object 101.

In some instances, performing one or more of subblocks 221, 223, 225, or 227 is sufficient for determining portions corresponding to complete boundaries 115 of the object 101 in the image 128 and the boundary detection system 110 does not need to perform all of these subblocks to determine the boundaries 115. For example, in some instances, performing one or more of subblocks 221, 223, or 225 is sufficient for determining complete boundaries 115 of the object 101 in the image 128 and the boundary detection system 110 does not need to perform subblock 227.

In some instances, combining the color channel data 128-1, 128-2, and 128-3 in various combinations and applying the edge detection algorithm to such combinations of color channel data can reveal various aspects of the boundaries 115 of the object 101 in the image 128. By selectively using information from one or two color channels of the three color channels 128-1 (e.g., green), 128-2 (e.g., blue), 128-3 (e.g., red) in the acquired image, individual edge shadow pixels will differ from adjacent non-shadow pixels significantly. In some instances, to detect portions of the boundaries 115, the boundary detection system 110 applies additional image processing to adjust dynamic range and gamma to further enhance the difference between shadow pixels and non-shadow pixels. In this manner all edges of the object 101 can be distinguished from one or more background objects 102 captured in the image by using distinctly-placed, spectrally-unique (differently colored) lighting devices 129 and a single capture image 128.

At block 230, the method 200 involves displaying an output on a user interface 123 based on the determined boundaries 115 of the scanned object 101 within the image 128. In some instances, the boundary detection system indicates the boundaries 115 on the user interface 123. Indicating the boundaries 115 can include annotating pixels of the image 128 corresponding to locations of the boundaries 115 or generating an object 117 image depicting only the object 101.

In some instances, implementing block 230 of method 200 involves implementing block 230A. At block 230A, the method for implementing block 230 involves indicating the boundaries 115 determined at block 220 in the user interface 123. For example, the boundary detection system displays the image 128 and annotates the boundaries 115 of the object 101 in the displayed image 128 by applying a shading, coloring, or other effect to the pixels corresponding to the boundaries 115.

In some instances, implementing block 230 of method 200 involves implementing block 230B. At block 230B, the method for implementing block 230 involves generating, for display on the user interface 123 based on the image 128 and on the boundaries 115 of the object 101 determined at block 220, an output image (object image 117) depicting the object 101. In some instances, the boundary detection system 110 generates, for display on the user interface 123, an output image of the object (object image 117) based on the detected boundaries 115 of the object 101. For example, the boundary detection system generates an object image 117 that only depicts the object 101 (e.g. the document of interest) and not any other features (e.g. documents upon which the document is stacked, a background of the scanning area, etc.) depicted in the image 128. In some instances, generating the object image 117 comprises rotating, resizing, warping, or performing other image modification operations to a subregion of the image depicted within the detected boundaries. For example, the object 101 depicted in the image 128 (e.g. a document stacked on a background object 102 document) is rotated 10 degrees from a vertical axis in the original image 128 but, in the displayed object image 117, is depicted aligned with the vertical axis. In another example, boundaries 115 of the object 101 depicted in the image 128 do not correspond to a predefined shape and generating the object image 117 includes resizing, warping, or performing other image modification operations to depict the object 101 according to a predefined shape. For example, the object 101 is a document and the predefined shape is a rectangle of predefined relative dimensions (e.g. 8.5×11 relative dimensions).

FIG. 3 illustrates detection of boundary portions of an object using color channel data of an image of the object illuminated using multi-directional spectrally distinct light sources, according to certain embodiments disclosed herein. For illustrative purposes, the FIG. 3 is described with reference to certain examples depicted in the figures. Other implementations, however, are possible. FIG. 3 illustrates detection of edge portions 301, 302, 303, and 304 (indicated by circled edges) of an object 101 (the depicted paper document) using color channel data 128-1, 128-2, and 128-3.

In the example illustrated in FIG. 3, the boundary detection system 110 detects edge portion 301 (a right edge) of the object 101 depicted in the image 128 using color channel data 128-1. The color channel data 128-1 represents, for each pixel of the image 128, an intensity of green light 103-1 illuminating the object 101. The boundary detection system 110 detects edge portion 302 (a bottom edge) of the object 101 depicted in the image 128 using color channel data 128-2. The color channel data 128-2 represents, for each pixel of the image 128, an intensity of blue light 103-2 illuminating the object 101. The boundary detection system 110 detects edge portion 303 of the object 101 depicted in the image 128 using color channel data 128-3. The color channel data 128-3 represents, for each pixel of the image 128, an intensity of red light 103-3 illuminating the object 101. In the example illustrated in FIG. 3, the boundary detection system uses combination color channel data 305 to detect edge portion 304 (a top edge) of the object 101 depicted in the image 128. The combination color channel data 305 is a combination of the color channel data 128-3 and the color channel data 128-1 corresponding to a combination of the green light 103-1 and the red light 103-3 illuminating the object 101 in the image 128. In the example illustrated in FIG. 3, the boundaries 115 of the document object 101 depicted in the image 128 are a combination of detected edge portions 301, 302, 303, 304 (right, bottom, left, and top edges).

### Examples of Computing Environments for Implementing Certain Embodiments

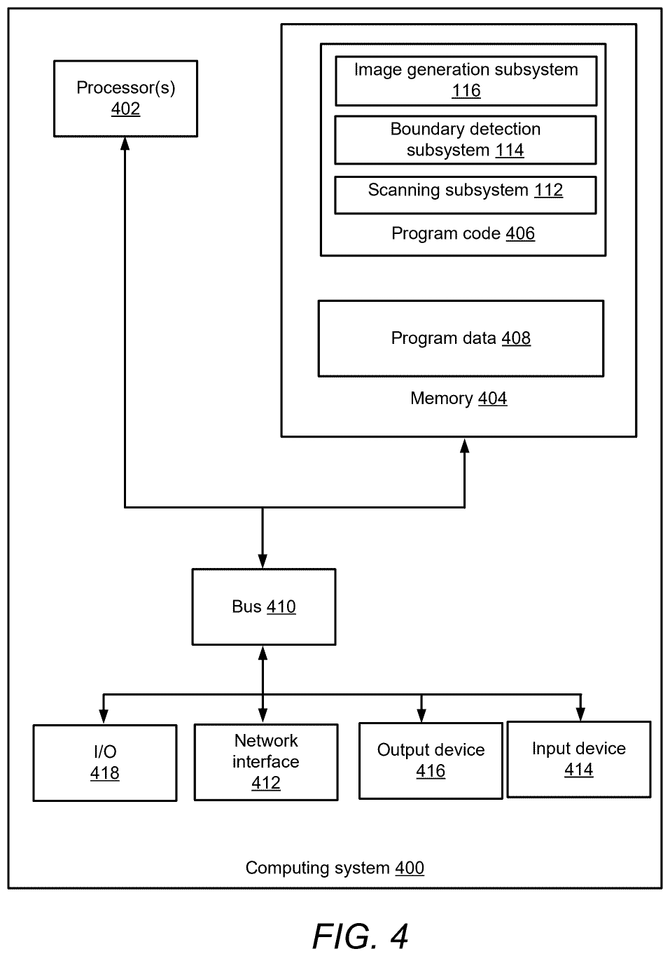

Any suitable computer system or group of computer systems can be used for performing the operations described herein. For example, FIG. 4 depicts an example of a computer system 400. The depicted example of the computer system 400 includes a processing device 402 communicatively coupled to one or more memory components 404. The processing device 402 executes computer-executable program code stored in a memory components 404, accesses information stored in the memory component 404, or both. Execution of the computer-executable program code causes the processing device to perform the operations described herein. Examples of the processing device 402 include a microprocessor, an application-specific integrated circuit (“ASIC”), a field-programmable gate array (“FPGA”), or any other suitable processing device. The processing device 402 can include any number of processing devices, including a single processing device.

The memory components 404 includes any suitable non-transitory computer-readable medium for storing program code 406, program data 408, or both. A computer-readable medium can include any electronic, optical, magnetic, or other storage device capable of providing a processing device with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. In various examples, the memory components 1204 can be volatile memory, non-volatile memory, or a combination thereof.

The computer system 400 executes program code 406 that configures the processing device 402 to perform one or more of the operations described herein. Examples of the program code 406 include, in various embodiments, the boundary detection system 110 (including the scanning subsystem 112, the boundary detection subsystem 114, and the image generation subsystem 116) of FIG. 1, which may include any other suitable systems or subsystems that perform one or more operations described herein (e.g., one or more neural networks, encoders, attention propagation subsystem and segmentation subsystem). The program code 406 may be resident in the memory components 404 or any suitable computer-readable medium and may be executed by the processing device 402 or any other suitable processor.

The processing device 402 is an integrated circuit device that can execute the program code 406. The program code 406 can be for executing an operating system, an application system or subsystem, or both. When executed by the processing device 402, the instructions cause the processing device 402 to perform operations of the program code 406. When being executed by the processing device 402, the instructions are stored in a system memory, possibly along with data being operated on by the instructions. The system memory can be a volatile memory storage type, such as a Random Access Memory (RAM) type. The system memory is sometimes referred to as Dynamic RAM (DRAM) though need not be implemented using a DRAM-based technology. Additionally, the system memory can be implemented using non-volatile memory types, such as flash memory.

In some embodiments, one or more memory components 404 store the program data 1208 that includes one or more datasets described herein. In some embodiments, one or more of data sets are stored in the same memory component (e.g., one of the memory components 404). In additional or alternative embodiments, one or more of the programs, data sets, models, and functions described herein are stored in different memory components 404 accessible via a data network. One or more buses 410 are also included in the computer system 400. The buses 410 communicatively couple one or more components of a respective one of the computer system 400.

In some embodiments, the computer system 400 also includes a network interface device 412. The network interface device 412 includes any device or group of devices suitable for establishing a wired or wireless data connection to one or more data networks. Non-limiting examples of the network interface device 412 include an Ethernet network adapter, a modem, and/or the like. The computer system 400 is able to communicate with one or more other computing devices via a data network using the network interface device 412.

The computer system 400 may also include a number of external or internal devices, an input device 414, a presentation device 416, or other input or output devices. For example, the computer system 400 is shown with one or more input/output (“I/O”) interfaces 418. An I/O interface 418 can receive input from input devices or provide output to output devices. An input device 414 can include any device or group of devices suitable for receiving visual, auditory, or other suitable input that controls or affects the operations of the processing device 402. Non-limiting examples of the input device 414 include a touchscreen, a mouse, a keyboard, a microphone, a separate mobile computing device, etc. A presentation device 416 can include any device or group of devices suitable for providing visual, auditory, or other suitable sensory output. Non-limiting examples of the presentation device 416 include a touchscreen, a monitor, a speaker, a separate mobile computing device, etc.

Although FIG. 4 depicts the input device 414 and the presentation device 416 as being local to the computer system 400, other implementations are possible. For instance, in some embodiments, one or more of the input device 414 and the presentation device 416 can include a remote client-computing device that communicates with computing system 400 via the network interface device 412 using one or more data networks described herein.

Embodiments may comprise a computer program that embodies the functions described and illustrated herein, wherein the computer program is implemented in a computer system that comprises instructions stored in a machine-readable medium and a processing device that executes the instructions to perform applicable operations. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computer systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

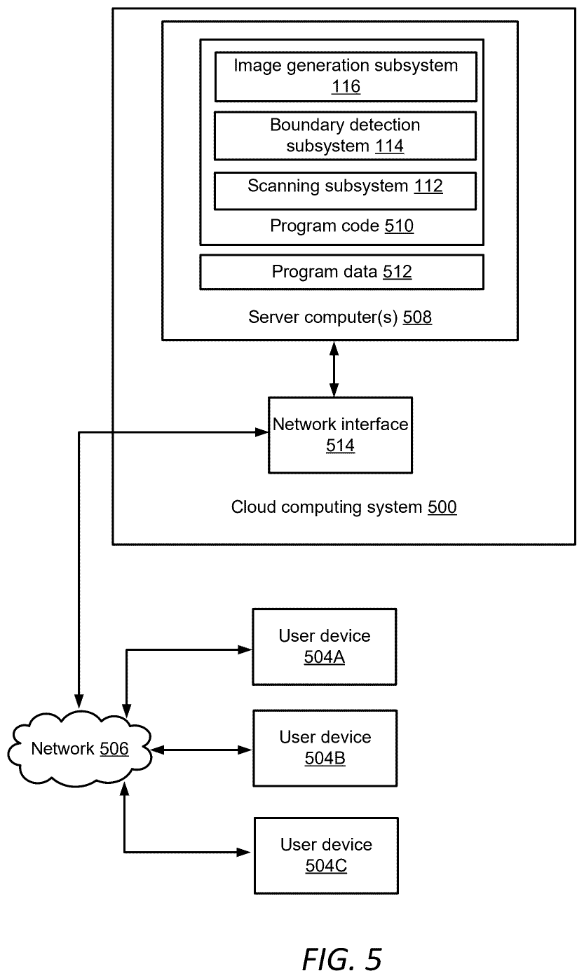

In some embodiments, the functionality provided by computer system 400 may be offered as cloud services by a cloud service provider. For example, FIG. 5 depicts an example of a cloud computer system 500 offering a service for detecting boundaries 115 of an object 101 in an image 128 of the object 101 illuminated using multi-directional spectrally distinct light sources 129, that can be used by a number of user subscribers using user devices 504A, 504B, and 504C across a data network 506. The cloud computer system 500 performs the processing to provide the service for detecting boundaries 115 of an object 101 in an image 128 of the object 101 illuminated using multi-directional spectrally distinct light sources 129. The cloud computer system 500 may include one or more remote server computers 508.

The remote server computers 508 include any suitable non-transitory computer-readable medium for storing program code 510 (e.g., scanning subsystem 112, the boundary detection subsystem 114, and the image generation subsystem 116 of FIG. 1) and program data 512, or both, which is used by the cloud computer system 500 for providing the cloud services. A computer-readable medium can include any electronic, optical, magnetic, or other storage device capable of providing a processing device with executable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. In various examples, the server computers 508 can include volatile memory, non-volatile memory, or a combination thereof.

One or more of the server computers 508 execute the program code 510 that configures one or more processing devices of the server computers 508 to perform one or more of the operations that execute a service for detecting boundaries 115 of an object 101 in an image 128 of the object 101 illuminated using multi-directional spectrally distinct light sources 129. As depicted in the embodiment in FIG. 5, the one or more servers providing the service for detecting boundaries 115 of an object 101 in an image 128 of the object 101 illuminated using multi-directional spectrally distinct light sources 129 may implement the scanning subsystem 112, the boundary detection subsystem 114, and the image generation subsystem 116. Any other suitable systems or subsystems that perform one or more operations described herein (e.g., one or more development systems for configuring an interactive user interface) can also be implemented by the cloud computer system 500.

In certain embodiments, the cloud computer system 500 may implement the services by executing program code and/or using program data 512, which may be resident in a memory component of the server computers 508 or any suitable computer-readable medium and may be executed by the processing devices of the server computers 508 or any other suitable processing device.

In some embodiments, the program data 512 includes one or more datasets and models described herein. In some embodiments, one or more of data sets, models, and functions are stored in the same memory component. In additional or alternative embodiments, one or more of the programs, data sets, models, and functions described herein are stored in different memory components accessible via the data network 506.

The cloud computer system 500 also includes a network interface device 514 that enable communications to and from cloud computer system 500. In certain embodiments, the network interface device 514 includes any device or group of devices suitable for establishing a wired or wireless data connection to the data networks 506. Non-limiting examples of the network interface device 514 include an Ethernet network adapter, a modem, and/or the like. The service for detecting boundaries 115 of an object 101 in an image 128 of the object 101 illuminated using multi-directional spectrally distinct light sources 129 is able to communicate with the user devices 504A, 504B, and 504C via the data network 506 using the network interface device 514.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included within the scope of claimed embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computer system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as an open and inclusive language that does not foreclose devices adapted to or configured to perform additional tasks or steps. Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Additionally, the use of “based on” is meant to be open and inclusive, in that, a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

What is claimed is:

1. A method, comprising:
accessing, by one or more computing devices, an image captured of an environment comprising a first object illuminated by a plurality of distinct wavelengths of light, each of the distinct wavelengths of light originating from emanating from respective lighting sources at respective distinct directions from the first object;
detecting, by the one or more computing devices and based on color channel data of the image corresponding to one or more of the plurality of distinct wavelengths of light, boundaries of the first object in the image; and
annotating, by the one or more computing devices, the detected boundaries in the image.

2. The computer-implemented method of claim 1, wherein the plurality of distinct wavelengths of light comprise a red wavelength, a blue wavelength, and a green wavelength.

3. The computer-implemented method of claim 1, wherein each of the respective distinct directions of the lighting sources comprises a perpendicular or opposite direction.

4. The computer-implemented method of claim 1, wherein the distinct wavelengths of light comprise distinct visible wavelengths of light.

5. The computer-implemented method of claim 1, wherein detecting boundaries of the first object in the image comprises:
applying, to color channel data of the image associated with one of the distinct wavelength of lights, an edge detection algorithm to determine at least a portion of the boundaries,
wherein the color channel data indicates, for each pixel of the image, an intensity of the one of the distinct wavelengths of light at the pixel.

6. The computer-implemented method of claim 5, wherein the applying the edge detection algorithm includes detecting a shadow effect in a region of the image indicated in the color channel data, wherein the region corresponds to the portion of the boundaries.

7. The computer-implemented method of claim 1, wherein detecting boundaries of the first object in the image comprises:
applying, to a combination of first color channel data of the image associated with a first distinct wavelength of light of the distinct wavelength of lights and second color channel data of the image associated with a second distinct wavelength of light of the distinct wavelength of lights different from the first distinct wavelength of light, an edge detection algorithm to determine at least a portion of the boundaries,
wherein the first color channel data indicates, for each pixel of the image, an intensity of the first distinct wavelength of light at the pixel, and
wherein the second color channel data indicates, for each pixel of the image, an intensity of the second distinct wavelength of light at the pixel.

8. A system comprising:
a memory component; and
a processing device coupled to the memory component, the processing device to perform operations comprising:
accessing an image captured of an environment comprising a first object illuminated by a plurality of distinct wavelengths of light, each of the distinct wavelengths of light originating from emanating from respective lighting sources at respective distinct directions from the first object;
detecting based on color channel data of the image corresponding to one or more of the plurality of distinct wavelengths of light, boundaries of the first object in the image; and
annotating the detected boundaries in the image.

9. The system of claim 8, wherein the plurality of distinct wavelengths of light comprise a red wavelength, a blue wavelength, and a green wavelength.

10. The system of claim 8, wherein each of the respective distinct directions of the lighting sources comprises a perpendicular or opposite direction.

11. The system of claim 8, wherein the distinct wavelengths of light comprise distinct visible wavelengths of light.

12. The system of claim 8, wherein detecting boundaries of the first object in the image comprises:
applying, to color channel data of the image associated with one of the distinct wavelength of lights, an edge detection algorithm to determine at least a portion of the boundaries,
wherein the color channel data indicates, for each pixel of the image, an intensity of the one of the distinct wavelengths of light at the pixel.

13. The system of claim 12, wherein the applying the edge detection algorithm includes detecting a shadow effect in a region of the image indicated in the color channel data, wherein the region corresponds to the portion of the boundaries.

14. The system of claim 8, wherein detecting boundaries of the first object in the image comprises:
applying, to a combination of first color channel data of the image associated with a first distinct wavelength of light of the distinct wavelength of lights and second color channel data of the image associated with a second distinct wavelength of light of the distinct wavelength of lights different from the first distinct wavelength of light, an edge detection algorithm to determine at least a portion of the boundaries,
wherein the first color channel data indicates, for each pixel of the image, an intensity of the first distinct wavelength of light at the pixel, and
wherein the second color channel data indicates, for each pixel of the image, an intensity of the second distinct wavelength of light at the pixel.

15. A non-transitory computer-readable medium storing executable instructions, which when executed by a processing device, cause the processing device to perform operations comprising:
accessing an image captured of an environment comprising a first object illuminated by a plurality of distinct wavelengths of light, each of the distinct wavelengths of light originating from emanating from respective lighting sources at respective distinct directions from the first object;
detecting based on color channel data of the image corresponding to one or more of the plurality of distinct wavelengths of light, boundaries of the first object in the image; and
annotating the detected boundaries in the image.

16. The non-transitory computer-readable medium of claim 15, wherein the plurality of distinct wavelengths of light comprise a red wavelength, a blue wavelength, and a green wavelength and wherein each of the respective distinct directions of the lighting sources comprises a perpendicular or opposite direction.

17. The non-transitory computer-readable medium of claim 15, wherein the distinct wavelengths of light comprise distinct visible wavelengths of light.

18. The non-transitory computer-readable medium of claim 15, wherein detecting boundaries of the first object in the image comprises:
applying, to color channel data of the image associated with one of the distinct wavelength of lights, an edge detection algorithm to determine at least a portion of the boundaries,
wherein the color channel data indicates, for each pixel of the image, an intensity of the one of the distinct wavelengths of light at the pixel.

19. The non-transitory computer-readable medium of claim 18, wherein the applying the edge detection algorithm includes detecting a shadow effect in a region of the image indicated in the color channel data, wherein the region corresponds to the portion of the boundaries.

20. The non-transitory computer-readable medium of claim 15, wherein detecting boundaries of the first object in the image comprises:
applying, to a combination of first color channel data of the image associated with a first distinct wavelength of light of the distinct wavelength of lights and second color channel data of the image associated with a second distinct wavelength of light of the distinct wavelength of lights different from the first distinct wavelength of light, an edge detection algorithm to determine at least a portion of the boundaries,
wherein the first color channel data indicates, for each pixel of the image, an intensity of the first distinct wavelength of light at the pixel,
wherein the second color channel data indicates, for each pixel of the image, an intensity of the second distinct wavelength of light at the pixel.
